(19) United States
(12) Patent Application Publication
(10) Pub. No.: US 2003/0083753 A1
(43) Pub. Date: May 1, 2003

(54) Photocuring system database

(76) Inventors: Rajdeep Kalgutkar, St. Paul, MN (US); Joel D. Oxman, Minneapolis, MN (US); Michael C. Palazzotto, Woodbury, MN (US); Wayne S. Mahoney, St. Paul, MN (US); Jacqueline S. Danner, Savage, MN (US); Nicholas J. Zitzer, Oakdale, MN (US)

Correspondence Address: 3M INNOVATIVE PROPERTIES COMPANY, PO BOX 33427, ST. PAUL, MN, 55133-3427, US

(21) Appl. No.: 10/014,390

(22) Filed: Oct. 22, 2001

(51) Int. Cl. G06F 7/00

(52) U.S. Cl. 700/1

(57) ABSTRACT

A photocuring system selection tool. A database containing a list of two or more elements of a photocuring system includes a name for each element and wavelength response information. Elements can be selected from the database and visual comparisons of the wavelength response can be shown. By categorizing wavelength response regions within the wavelength response information, components of a photocuring system can be selected so that overlap among wavelength response of system elements can be assured and a working photocuring system thereby designed.

### BACKGROUND OF THE INVENTION

Photocuring is used in many circumstances to reduce costs and improve environmental compliance while providing high quality bonding. In photocuring, a light source is placed so that the light can interact with certain chemicals in the materials to be bonded. Such a curing method can be used in coatings, furniture, electronics, automotive, packaging, optical fibers, dentistry and many other applications.

Fields in which photocuring can be used include, but are not limited to, graphic arts imaging, printing plates, photoresists, solder masks, coated abrasives, magnetic media, photocurable adhesives, photocurable composites, coatings, foams, shaped articles, caulking and sealing compounds, potting and encapsulated compounds, impregnating and coating compounds,

One advantage to the use of photocuring is that few volatile organic compounds (“VOC's”) are used in the process. This is important in meeting tougher and tougher emissions requirements. A further advantage is that less energy is generally used when employing photocuring systems as opposed to other curing methods.

A photocuring system requires at least three elements: a light source; a photoinitiator and a polymerizable material. The photoinitiator absorbs light from the light source and initiates a chemical reaction that causes the polymerization to occur. The polymerizable material is the material which will react with the photoinitiator when the photoinitiator is activated. Other chemicals may be present with the photoinitiator to accomplish the desired chemical reaction.

Photopolymerization of monomers using V, visible or near infrared light to prepare cured compositions is an established part of polymer chemistry. Numerous photopolymerizable compositions, for example, those comprising ethylenically-unsaturated monomers and at least one photoinitiator, have been photopolymerized using light radiation. A necessary condition for these photopolymerizations is that the photopolymerizable compositions must be directly exposed to the light irradiation in order for the photoinitiating component to generate the free radicals or acids required to initiate the photopolymerization process. Alternative photopolymerization systems may include those activated by cationic, metal species and the like. Numerous industrial processes rely on selective light photopolymerization, wherein a mask is used to block light irradiation to specified areas of a surface or substrate so that photopolymerization takes place only in the exposed areas.

In the electronics industry as an example, numerous methods have been used to bond electronic components together for purposes of forming multi-layer components or simply adhering a component to a substrate. Methods involving photopolymerization have generally been limited to situations where at least one of the substrate or the component is essentially transparent to light irradiation. However, in the case of bonding components to a printed circuit board (PCB), this seldom is possible, since PCBs are often made of opaque and colored materials and they usually are at least partially covered with metallic circuit traces. In addition, the electronic component itself, e.g., a chip, typically is completely non-transmissive to electromagnetic radiation. In general, the electronics industry has turned to thermally polymerizable adhesives when reinforcement of solder bonds is desired. This is not entirely satisfactory because of the lengthy thermal curing cycles required. In addition, some electronics components may be heat sensitive and free-radical thermal polymerizations in general do not lend themselves to patterned or selective activation.

While photopolymerization has been used in the bonding of electronic components, results have not always been satisfactory. For example, surfaces to be joined have been coated with a photopolymerizable adhesive, followed by irradiating the adhesive, then placing the two parts together and allowing the irradiated adhesive to completely cure. Alternatively, irradiation at the peripheral edges of parts to be joined can result in a bond of sufficient strength to temporarily hold a component in place. Often, heating the joined components is necessary for complete curing.

Curing of photopolymerizable adhesives by light irradiation through a substrate is known. For example, DE 3939628 discloses bonding of electronic components to aluminum oxide or aluminum nitride ceramic substrates that are up to 1500 μm thick by light irradiation of at least 50 mW/cm² output density. Transmission of UV light through an aluminum oxide ceramic substrate of 1016 μm thickness is reported to be about 0.6%.

U.S. Pat. No. 4,656,314 discloses curing of a conductive metal-coated light-curable ink on a translucent PCB by light irradiation from both the top and bottom of the PCB, wherein at least some of the UV light passes through the substrate from the underside to assist in the complete curing of the ink. The substrate is characterized as a sheet of polyester or polycarbonate that must be at least partially translucent, preferably more than 50% transmissive to light. Conventional print treated MYLAR (Dupont) is described as an effective commercially available substrate.

U.S. Pat. No. 5,065,505 discloses a method of connecting circuit boards wherein a photocurable adhesive is coated onto a light-transmissive circuit board on which electrodes have been formed. Irradiation through the circuit board from the side opposite the coated side, cures the adhesive in areas not shaded by the electrodes. Exemplified photoinitiators have absorption peak wavelengths ranging from 240 nm to 365 nm. Photoinitiators useful in the visible light range are not described. Suitable circuit board substrates include polyimide resin, polyester resin, and the like.

Japanese Kokai Application JP 7-106723 discloses curing of adhesives through a flexible circuit board that is transmissive to 5% or more light having a wavelength between 350 and 400 nm. Base films, through which light-curing takes place, can include poly(etherimide), poly(ethersulfone), polyethylene naphthalate, polyether ether ketone, polycarbonate, and polyethylene terephthalate.

Japanese Examined Application JP 7-81114 discloses curing a photohardenable adhesive in the presence of a diketone photoinitiator and a dialkyl amino benzophenone photosensitizer by irradiation through a semitransparent substrate using irradiation wavelengths up to 436 nm.

U.S. Pat. No. 5,607,985 discloses a photopolymerization initiator for visible-light polymerizing adhesives comprising a photopolymerization initiator, an aliphatic tertiary amine and a radical polymerizable monomer. Adhesion of a sandwich construction comprising two opaque glass pieces, each having 10% light transmissivity at 510 nm and 0% light transmissivity between 490 and 200 nm, on exposure for two minutes to a metal halide lamp, is described.

U.S. Pat. No. 5,798,015 discloses generating reactive species (radicals) by providing a wavelength-specific sensitizer in association with a reactive species-generating photoinitiator and irradiating the wavelength-specific sensitizer. The method is used to laminate at least two layers together by coating the adhesive between the layers and irradiating to effect polymerization thereof, providing that at least one of the layers is a cellulosic or polyolefin non-woven web or film and the sensitizer is one of a set of specified arylketoalkene moieties.

Optical recording discs, such as compact discs and CD-ROMs, often comprise two or more layers of a polymeric base substrate, each of which comprises a recording layer, bonded together by an adhesive with both recording layers facing each other. Typically, the recording layers comprise an opaque metal foil. Uniform curing of the adhesive between the foils is difficult. U.S. Pat. No. 5,360,652 discloses such an optical recording disc, wherein the adhesive is a photocurable adhesive. In order to adhere the two discs together, the recording medium is configured not to extend to the periphery of the discs so that light irradiation rapidly cures the adhesive around the edges of the disc, allowing the masked adhesive under the recording medium to cure only by contact with photoinitiators in the irradiated region.

U.S. Pat. No. 5,785,793 discloses one- or two-sided irradiation of an optical recording disc having one or two back-to-back storage medium layers. Curable adhesive is used on the side opposite from the recording medium, in either case, so that light irradiation must pass through at least the recording medium in order to cure the adhesive. Heat management is an issue for optical recording disc manufacture, since the discs are easily warped and the recording medium is typically a low-melting metal, such as aluminum. Xenon flash lamps are preferred for irradiating the curable adhesive and bonding the discs together.

Bonding of DVD (Digital Versatile Disk) substrates is described by D. Skinner, “UV Curing Through Semi-transparent Materials—The Challenge of the DVD Bonding Process,” RadCure Letter, April, 1998, p. 53-56, wherein light of 320-390 nm wavelengths is shown to penetrate a 40 nm thick coating of aluminum on a polycarbonate substrate. Curing of an adhesive under these conditions is not disclosed.

However, curing by photopolyermization is sometimes hampered by all of the choices available to a designer. In particular, there is a common misperception that any light with a UV component will work with any photoinitiator to accomplish curing.

### SUMMARY OF THE INVENTION

The present invention is an apparatus and method for use in designing photocurable systems. A database is provided including two or more element type fields. Each element type field has a list of elements. Each element is stored by name and has a respective wavelength response field where information about the wavelength response of the element is stored. In a preferred embodiment, the data base may be accessed through a website.

Using the database, a photocuring system can be designed. The process for building a photocuring system involves selection of two or more system element types. The photocuring system elements can be used to pick elements to work with a photopolyermizable material. These elements may include one or more of, a light source, a substrate as well as other element types, including photoinitiators, dyes, sensitizers, UV stabilizers, pigments, fillers, minerals, particulates, plasticizers, thermal stabilizers, anti-oxidants, and the like. Any of the system elements may be selected first. After selection of the first element, a second element is picked from a list of possible second elements which can be used with the first element to produce an operable curing system. After selection of the first and second elements, if desired, a third element is selected from a list of possible third elements which can be used with the first and second elements to produce an operable curing system.

In another preferred embodiment of the invention, a first system element may be picked having a wavelength profile. The user is then presented only with a list of second elements that have at least a portion of their wavelength responses above a predetermined level at one or more wavelengths in which the first system element has a wavelength response above a predetermined level.

The database can also be used to compare the wavelength responses of different examples of the same elements types. For example, two light sources can be compared. As a further example, a substrate can be compared to two light sources.

### BRIEF DESCRIPTION OF THE DRAWING

FIG. 1 is a table from the inventive database showing possible light sources.

FIG. 2 is a table from the inventive database showing possible photoinitiators.

FIG. 2A is a table from the inventive database showing possible UV stabilizers.

FIG. 3 is a table from the inventive database showing possible substrates.

FIGS. 4A-B is a flow chart a preferred embodiment of the inventive method.

FIGS. 4C-G are flow charts showing a second embodiment of the inventive method.

FIGS. 5A-C show a representative wavelength response profile of one component.

FIGS. 6A-F show screens from a computer implementing the method of FIGS. 4A-4D.

FIG. 6G shows an overlay diagram of the wavelength responses of a first photoinitiator, substrate and light source.

FIGS. 7A and B show alternate overlay diagrams with second and third sets of photoinitiators, substrates and light sources.

FIG. 7C shows another photoinitiator, substrate and light source system with a significant area of overlap on the wavelength response graphs.

FIGS. 7D-G show comparisons of two or more elements without building a complete photocuring system from the process shown in FIG. 4F.

FIGS. 7H and I show element profiles according to the present invention.

FIGS. 8A-D show subprocesses for interpolating, baselining, normalizing and integrating data respectively, to analyze the data visually and numerically.

FIG. 9 shows the process of determining whether a particular region within a wavelength response shows significant enough response to be categorized by a symbol.

FIG. 10 shows a system diagram of a number of different computer systems in which the present invention could be implemented.

FIG. 11 is a flow chart of the wavelength response graphing process.

### DETAILED DESCRIPTION OF THE PREFERRED EMBODIMENT

At the heart of the system is a database that stores selected information about system elements such as light sources, photoinitiators, substrates, dyes, inhibitors, sensitizers, UV/thermal stabilizers, colorants, pigments, fillers, minerals, particulates plasticizers and the like and possibly other photopolymerizable elements that could be used in a photocuring system. Any material usable in a photopolymerization system could be included in the database. Each element is stored using at least a name and a wavelength range.

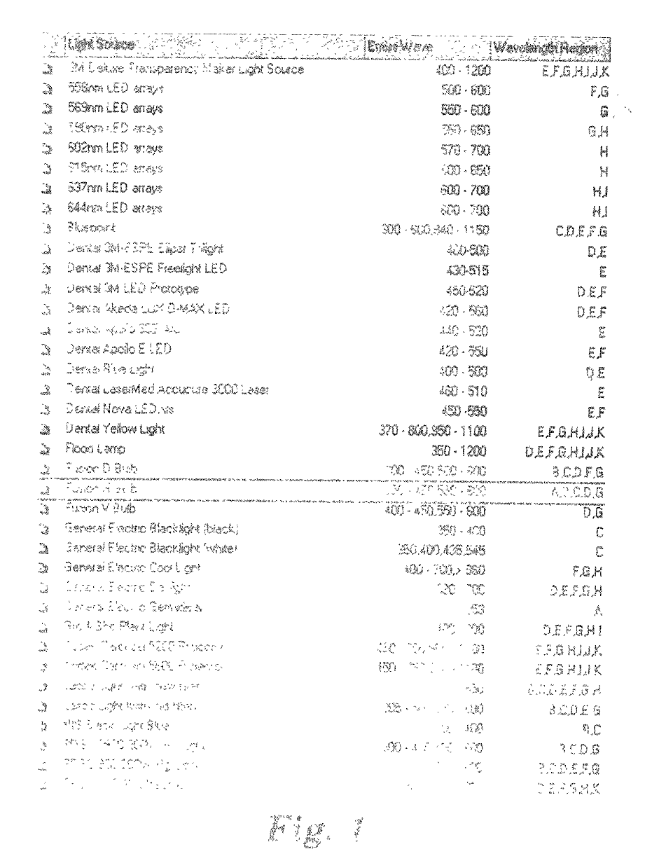

Referring now to FIG. 1, thereshown is a sample database table showing possible light sources. Each light source has a name and includes a description of the light wavelengths present at least at a minimum level produced by the light source. In addition, the wavelength ranges have been broken into, in this case, 50 nm “regions” (except for the last region) with each region being assigned a letter. Other regions could be defined, such as regions of unequal width, and other symbols could be used, but both still fall within the spirit of the invention.

| Wavelength Region Name | Wavelengths Represented |
|---|---|
| A | 250-300 nm |
| B | 301-350 nm |
| C | 351-400 nm |
| D | 401-450 nm |
| E | 451-500 nm |
| F | 501-550 nm |
| G | 551-600 nm |
| H | 601-650 nm |
| I | 651-700 nm |
| J | 701-750 nm |
| K | 751 nm |

These letters are useful for categorizing elements in the database and comparing the effective region of one element with the effective ranges of the other elements in a shorthand way. For each wavelength region in which a light source radiates significantly within the region, a letter is placed in the database corresponding to the wavelength region. Lastly, a set of data points representative of output intensity vs. wavelength, is stored. To determine whether the wavelength response is sufficiently strong to be identified as being present in a particular wavelength region, the process of FIG. 9 is used. The process may be implemented using the program attached as Appendix 3.

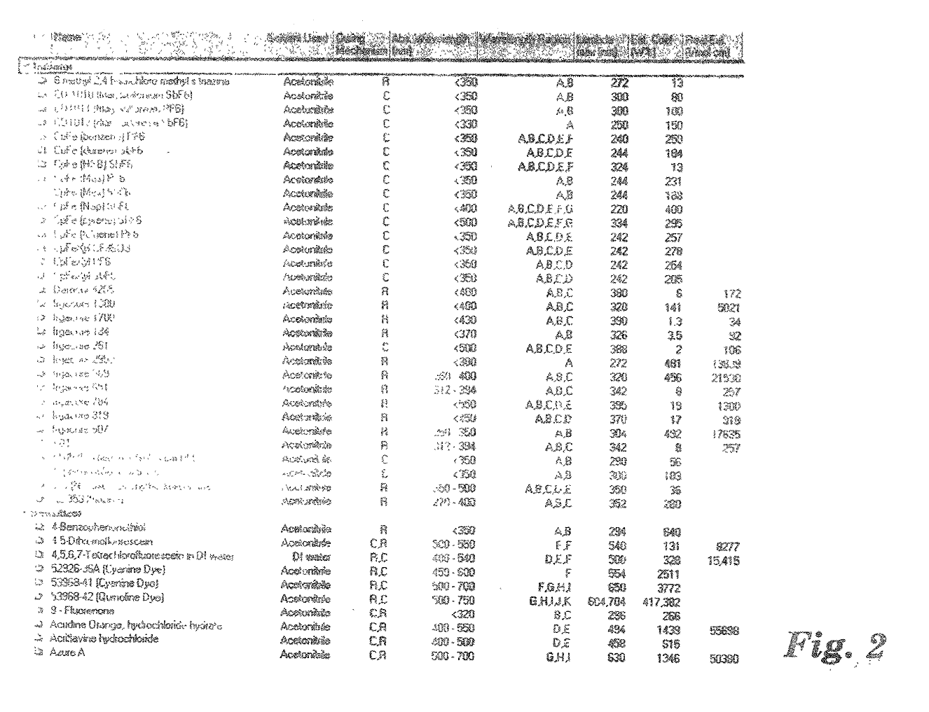

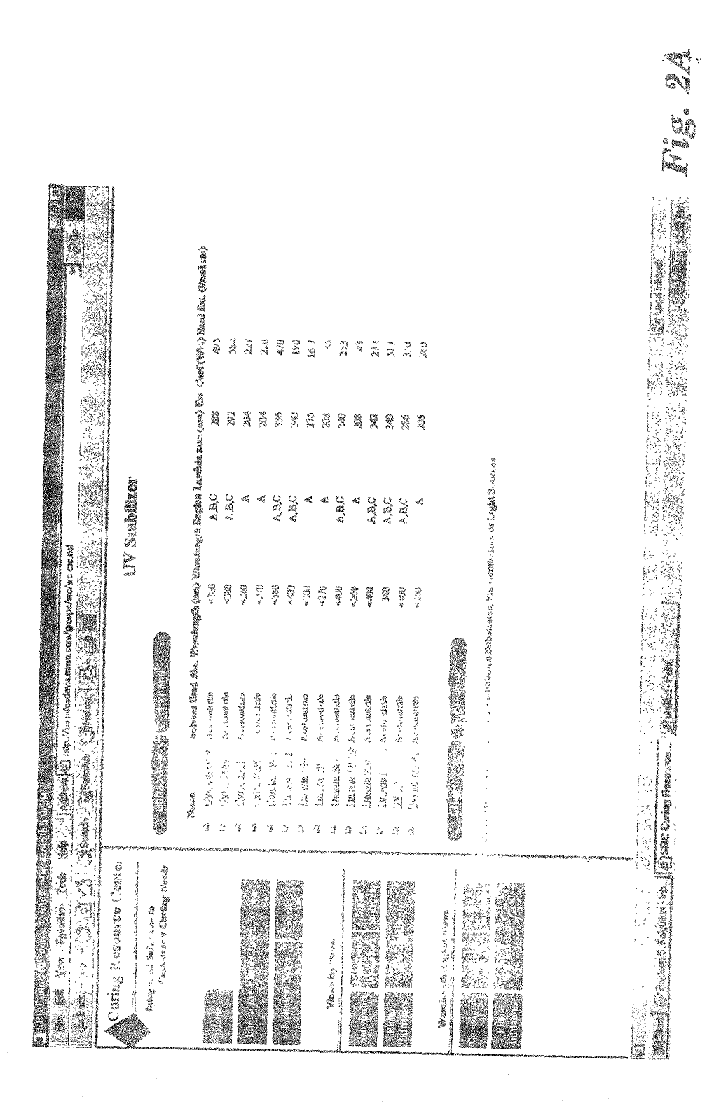

In FIG. 2, thereshown is a sample database table showing possible photoinitiators. Each photoinitiator is stored with a name, wavelength(s) for which they will absorb radiation, wavelength regions for absorption and datapoints (not shown in detail) for the absorption curve. In addition, a curing mechanism field may be included which identifies whether a cationic or free radical reaction will occur when the chemical reaction is initiated.

In FIG. 2A, thereshown is a sample database table showing possible UV stabilizers. Each UV stabilizer is stored with a name, wavelength for which they absorb radiation, wavelength regions for absorption and datapoints (not shown in detail) for the absorption curve.

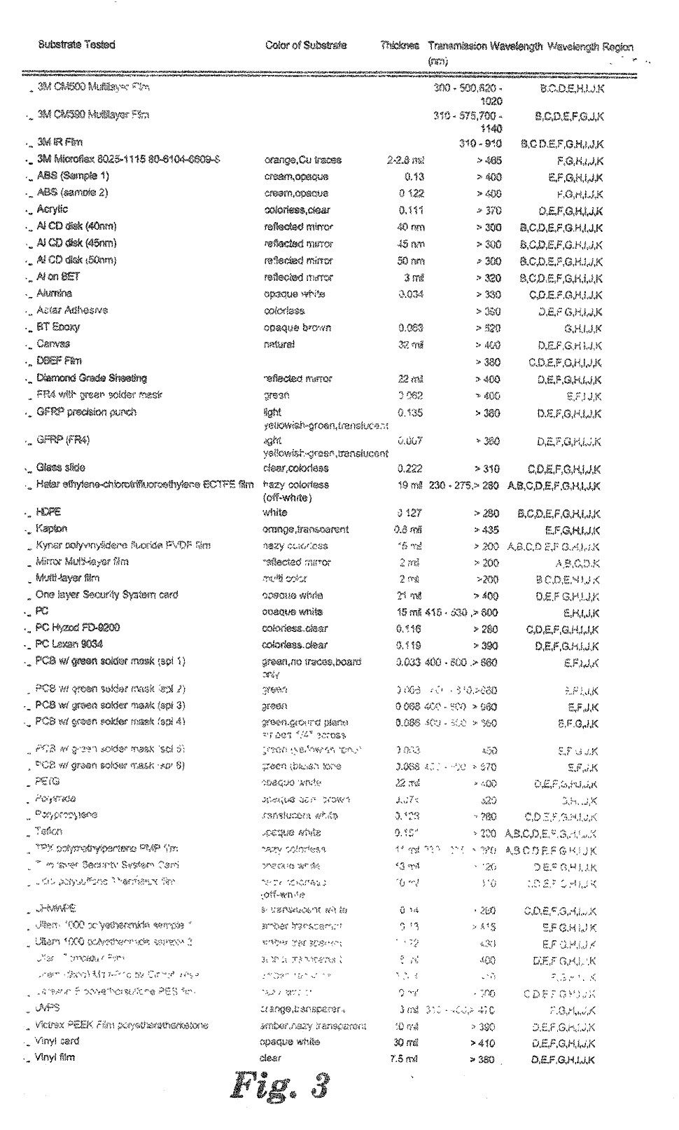

In FIG. 3, thereshown is a sample database table showing possible substrates. Each substrate is stored with a name, wavelength(s) in which the substrate will allow radiation to pass (transmission wavelengths), wavelength regions as identified in the wavelength table above for the transmission wavelengths and data points (not shown in detail) for the transmission curve of the substrate at a preselected thickness.

The database may be built using any conventional database software. For example, Lotus Notes™ database software may be used to create individual profiles for each system element to be used. Data associated with the element, such as wavelength response data may be stored, for example, in a Microsoft Excel™ spreadsheet that can be attached to the Lotus Notes™ profile for each element.

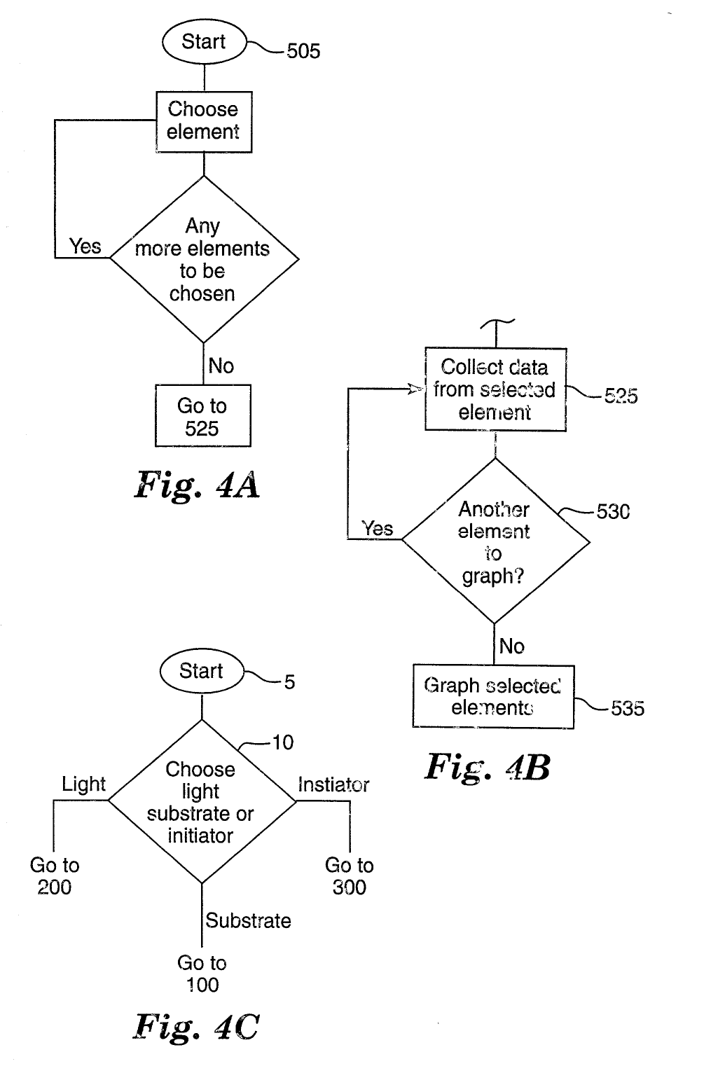

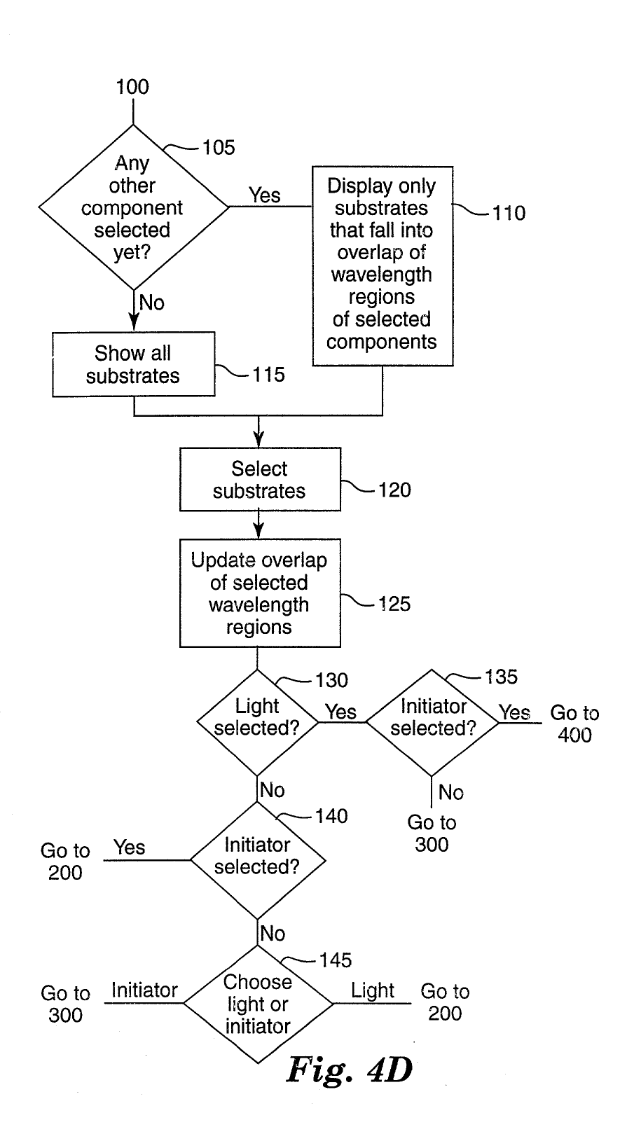

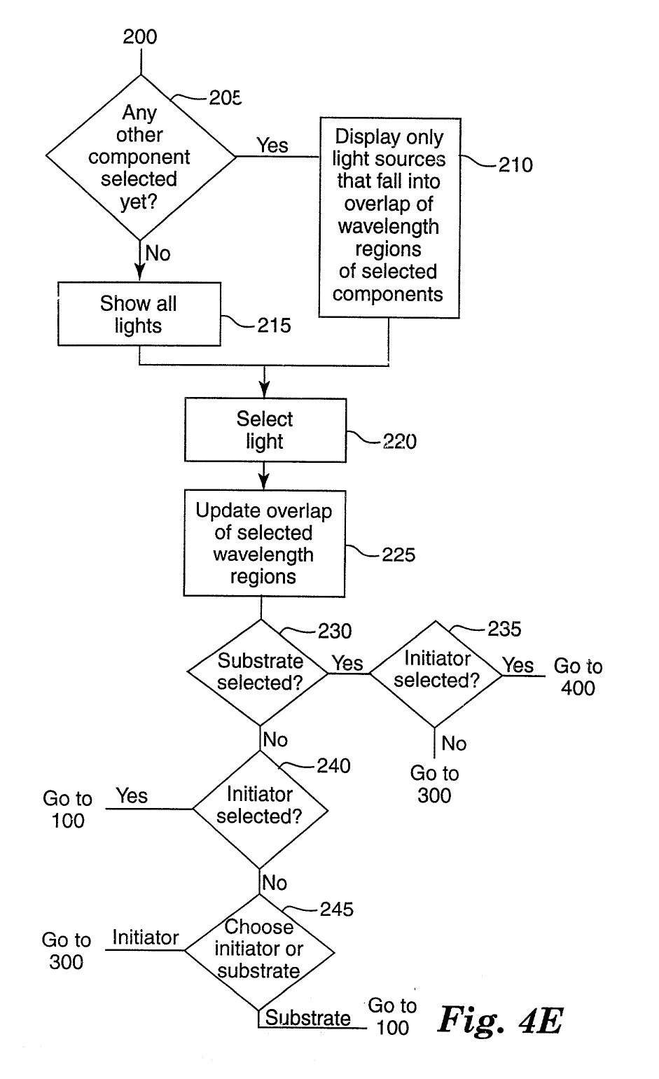

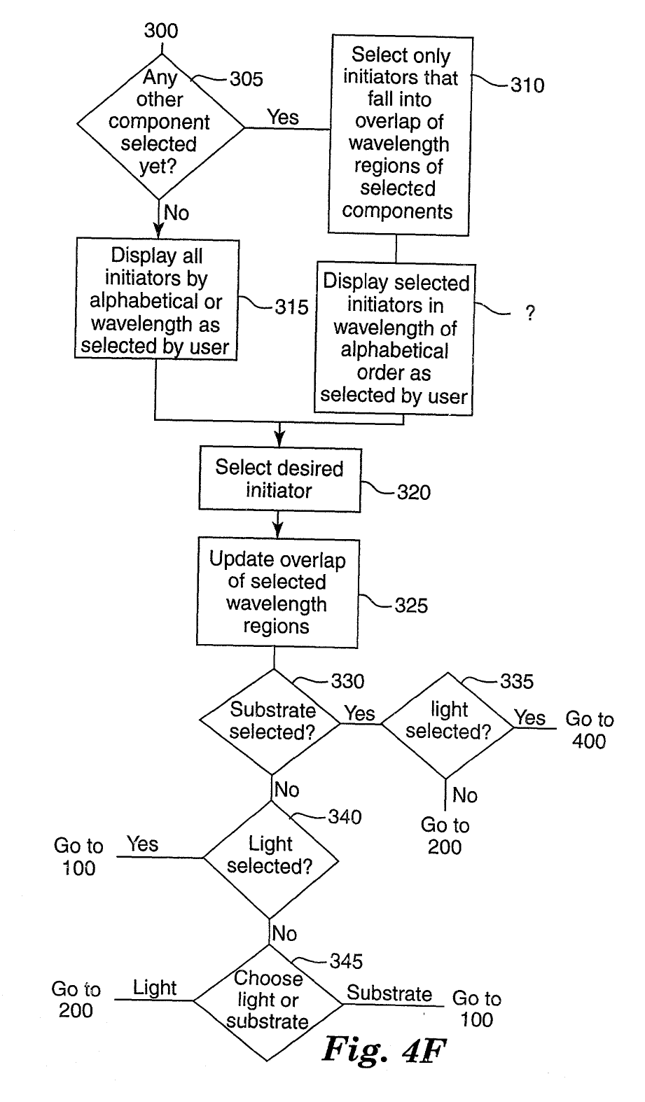

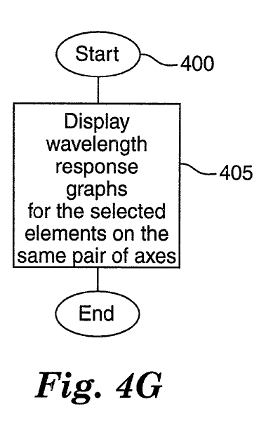

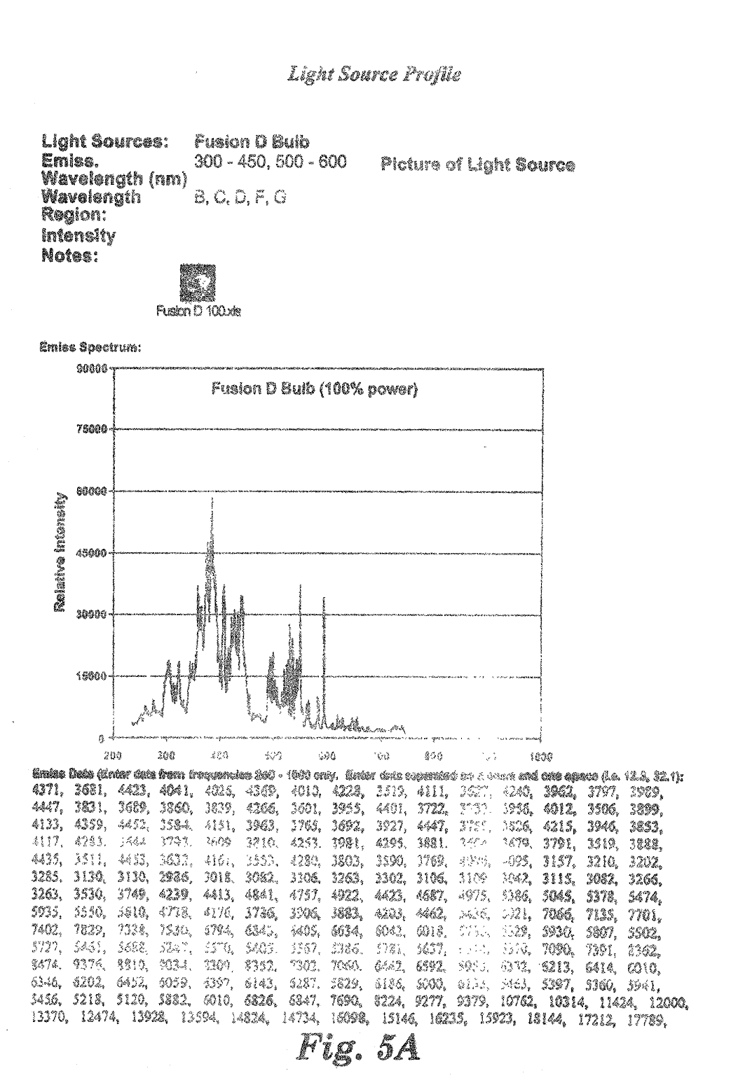

The basic process of picking elements to compare is shown with reference to FIG. 4A. Thereshown is a process for selection of the components and display of their wavelength response charts. After starting at block 505, the user selects an element at block 510. At block 515, the user determines whether they want to choose any other elements. If so, the process loops back to block 510. If not, the process continues to block 520 where the process moves to the graphing process at block 525.

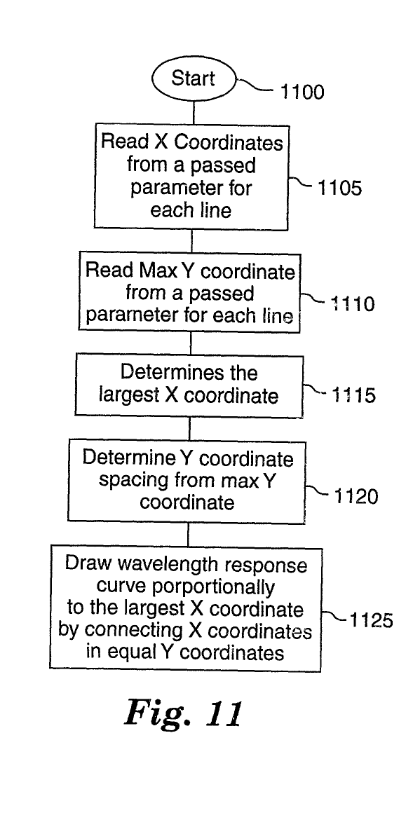

The method of obtaining the information to graph is shown with respect to FIG. 4B. The process pulls the wavelength response data for a first selected element from the profile for that element at block 525. At block 530, the process determines whether more than one element was selected and if not, the process goes to block 535 where the graphing of the wavelength response of the selected element occurs. If more than one element was chosen, the process then moves back to block 525 where the wavelength response data for the second element is collected from the profile for that element. Again, at block 530, the process determines if a third element is present, and if not, the process graphs the wavelength response of the first and second elements at 535. If there is a third element, the wavelength response data for that element is collected from the profile for that element at block 525 and then all three wavelength responses are graphed at block 535. The processes for actually graphing the data is done using, for example, a java applet in connection with FIG. 11. An example of the a java applet for this purpose is attached as Appendix 5.

In FIGS. 4C-4G, thereshown is a second method of implementing the present invention. This method is a subset of the method described in FIGS. 4A and B and may be used to pick a system of a light source, a photoinitiator and a substrate that will produce a viable photocuring system. After starting at block 5, the process moves to decision block 10 to determine what the user wants to select first, a light source, a substrate or a photoinitiator. If a substrate is selected, the process moves to 100. If a light source is selected, the process moves to 200. If a photoinitiator is selected, the process moves to 300.

In FIG. 4D, the substrate selection process beginning at 100 is shown. At decision block 105, the process determines whether any other component of the system has been selected yet. If the answer is yes, the process at block 110 will display only substrates that match the wavelength response (spectral characteristics) as the other selected components. If not, the process shows a list of all substrates stored in the system at block 115. At block 120, the user must select the substrate to be used. A memory (not shown) will store at block 125 the characteristics of the substrate chosen for use in selection of other components. At block 130, the selection of the next components begins. If a user has already selected a light source next, the process determines at block 135 whether a photoinitiator has yet been selected. If so, the process moves to 400. If not, the process moves to block 300.

If a light source has not been selected at block 130, the process determines if a photoinitiator has been selected at block 140. If so, the process moves to block 200. If not, the process moves to block 145 where the user must determine whether to pick a photoinitiator or a light source. If a photoinitiator is chosen, the process goes to 300. If a light is chosen, the process goes to 200.

In FIG. 4E, after beginning at 200, the process moves to decision block 205 where the process determines whether any other components have been selected yet. If yes, the process will display at block 210 only those light sources that generate light at a wavelength that overlaps the wavelengths of the components already selected (matches the spectral characteristics). If not, then all light sources are displayed. At block 220, the user is asked to select a light source. At block 225, the memory is updated with the characteristics of the light source selected and an overlap of light wavelength regions is updated in the memory. At block 230, the process determines if a substrate has already been selected. If so and a photoinitiator has not yet been selected, as determined at block 235, then the process moves to block 300. If so and a photoinitiator has been selected, as determined at block 235, then the process moves on to 400. If at block 230, a substrate has not been selected and if a photoinitiator has been selected, as determined at block 240, the process moves to block 100. If a photoinitiator hasn't been selected as determined at block 240, then the user must decide whether to pick a photoinitiator next or a substrate. If the user picks a photoinitiator, the process moves to block 300. If the user picks a substrate, then the process moves to 100.

In FIG. 4F, after beginning at block 300, the process moves to decision block 305 where the process determines whether any other components have been selected yet. If yes, the process will display at block 310 only those photoinitiators which absorb light at a wavelength that falls into the overlap of the wavelengths of the components already selected. If no, then all of the photoinitiators are displayed at block 315. In either event, the process moves to block 320 where the user selects a desired photoinitiator. At block 325, the memory is updated with the characteristics of the photoinitiator selected and an overlap of light wavelength regions is updated in the memory. The process then moves on to block 330 where the process determines if a substrate has already been selected. If so, the process moves on to block 335 where it determines if a light has already been selected and if so, the process moves to 400, otherwise the process moves to 200. If at block 330, a substrate has not already been selected the process determines at block 340 whether a light has already been selected and if so, the process moves to 100. Otherwise, the process moves to block 345 where the user is asked to choose either a light or a substrate. If the user chooses to pick a light, the process moves to block 200. If the user chooses to pick a substrate, the process moves to block 100.

While the process of selecting elements in a desired photocuring system is essentially complete through use of the process in FIGS. 4C-F, it may be useful to graph the wavelength responses of the chosen elements to get a graphical display of the areas of overlap in the elements' wavelength responses as shown by the process in FIG. 4G. After starting at block 400, the process displays the wavelength response of the chosen elements on the same pair of axes at block 405. This can be done by taking data stored in a Microsoft Excel™ spreadsheet, for example, and displaying it graphically. More on this is process is described below in FIG. 11.

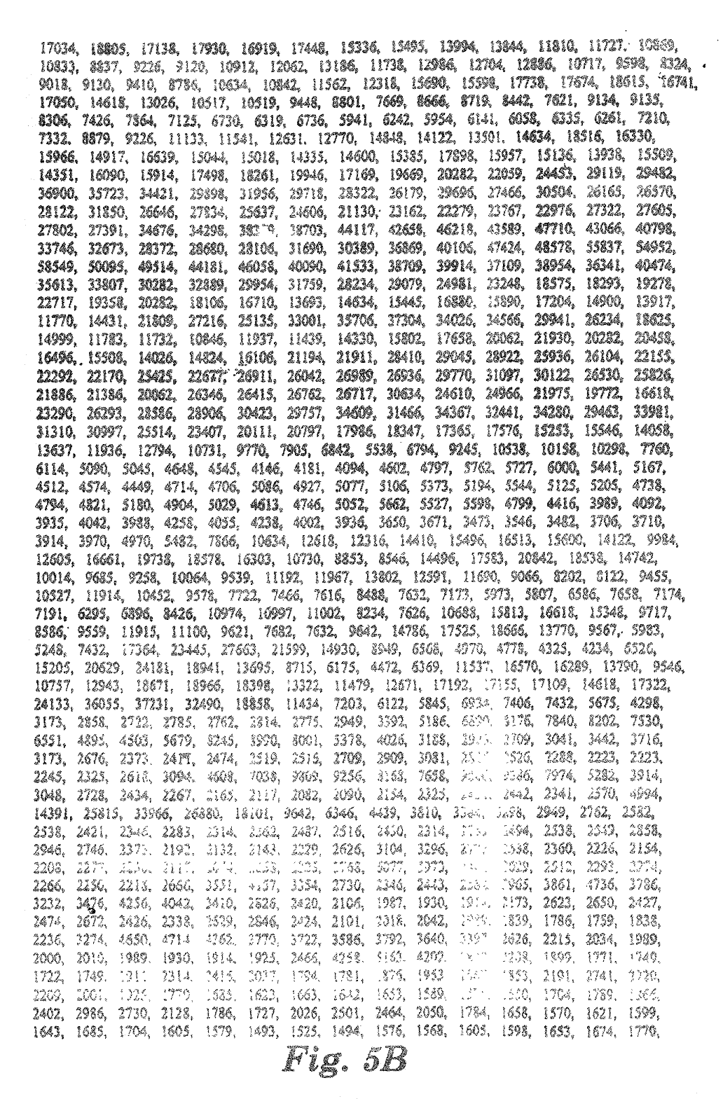

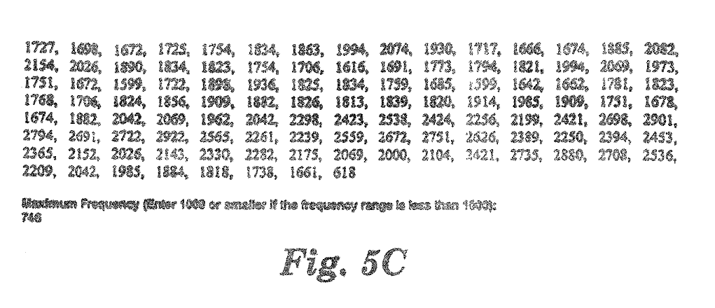

Referring now to FIGS. 5A-C, thereshown is a profile of an individual light source as an example. The information in the profile would be entered by a user into the database. The profile information would include the name of the element, here a Fusion D Bulb, the relevant wavelengths, here 300-400, 500-600 nm, wavelength regions, here B, C, D, F and G; a chart showing relative intensity vs. wavelength (for light sources) and finally emission data. In a preferred embodiment, the emission data will be for wavelengths between 200 and 1000 nm only, the data will begin at 200 nm and the maximum wavelength at which an emission occurs is identified. This information will become important when adjusting the data so that comparisons between the various components are meaningful. Profiles for a substrate would be similar except that the wavelength data would be representative of the extent of transmission of light at particular wavelengths passing through the substrate. Profiles for photoinitiators would likewise be similar except that the wavelength data would be representative of the relative absorbance levels of light impinging on the photoinitiator.

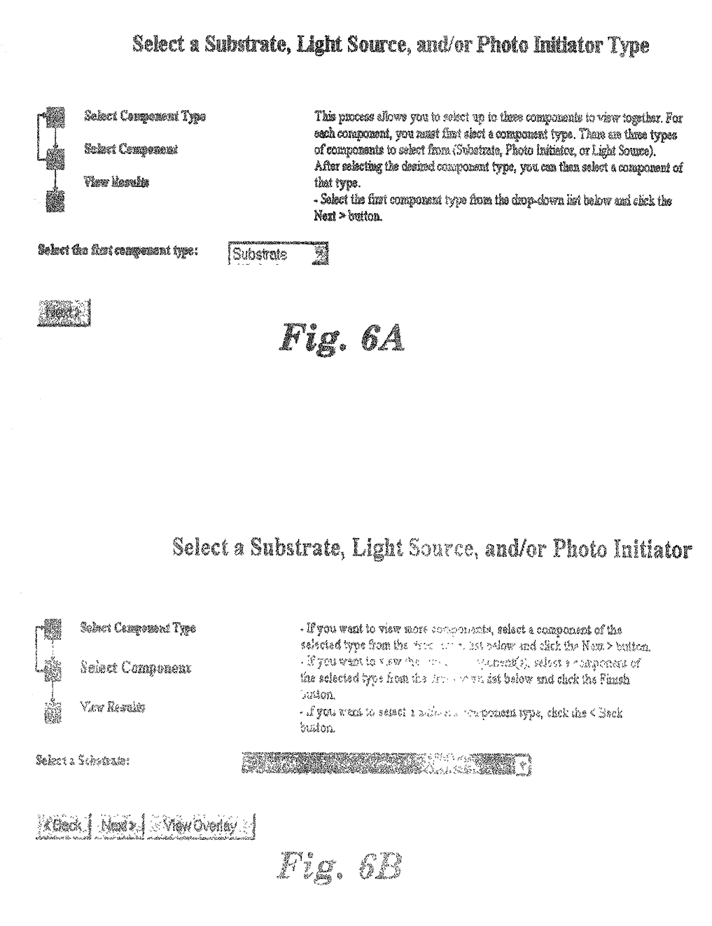

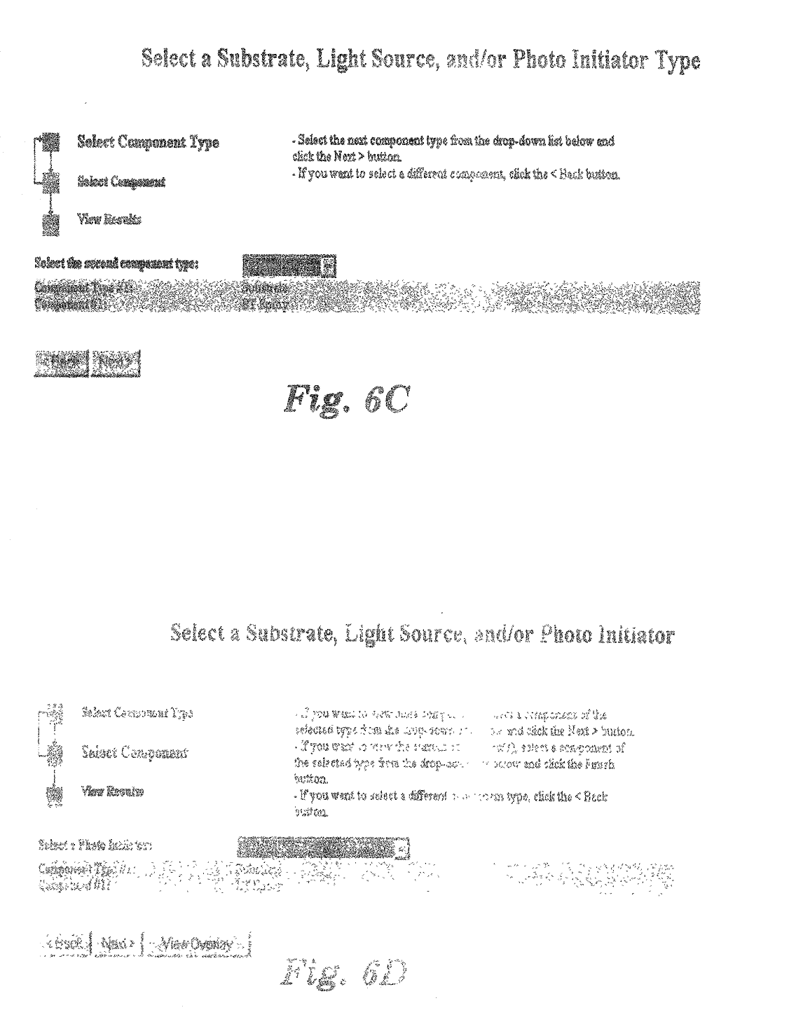

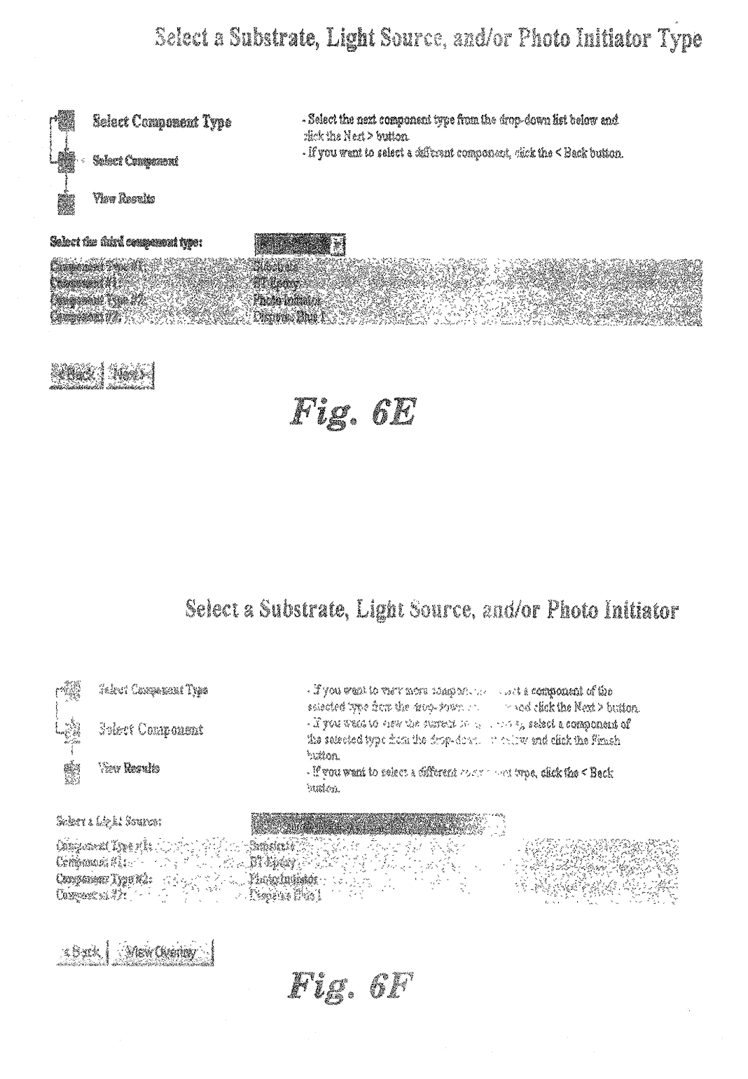

Referring now to FIGS. 6A-H, thereshown are screenshots of a computer implementing the present invention to select the components of a photocuring system from the elements contained in the database. In FIG. 6A, the process begins by a user picking either a substrate, a light source or a photoinitiator. Here, the user has indicated that they want to select a substrate first. Next, in FIG. 6B, a full list of substrates is presented to the user. Here, the user has elected to use a substrate of BT Epoxy. In FIG. 6C, the first component type selected (Substrate) and the specific component (BT Epoxy) are displayed while the user is given the opportunity to select the second component type. Here, the user has selected a photoinitiator. In FIG. 6D, the user would be presented with only the photoinitiators having a wavelength region that matches at least one wavelength region of the BT Epoxy. Here, the user has selected Disperse Blue 1 as the photoinitiator. It will be appreciated by those of ordinary skill in the art that when a dye or sensitizer such as Disperse Blue 1 or Methylene Blue is chosen as the photoinitiator, another component must be added to make a viable photocurable system. In FIG. 6E, the user is asked to pick the third component type. Note that information about the first component type, first component, second component type and second component are displayed to the user. Here, the user has selected a light source as the third component type. In FIG. 6F, the user selects a Bluepoint light.

In FIG. 6G, an overlay diagram is created by the computer. The overlay plots the wavelength responses of each of the components of the photocuring system on a graph on which the components can be compared. In general, photocuring systems will only work in the wavelengths where the three graphs overlap. Further, the greater the area in common under the three curves, the more efficient the curing system will be. As can be seen from the Figure, the graph is presented in such a form that a standard web browser such as Internet Explorer™ software can be used to display the graph. Other tools well known in the art may also be used to present the information.

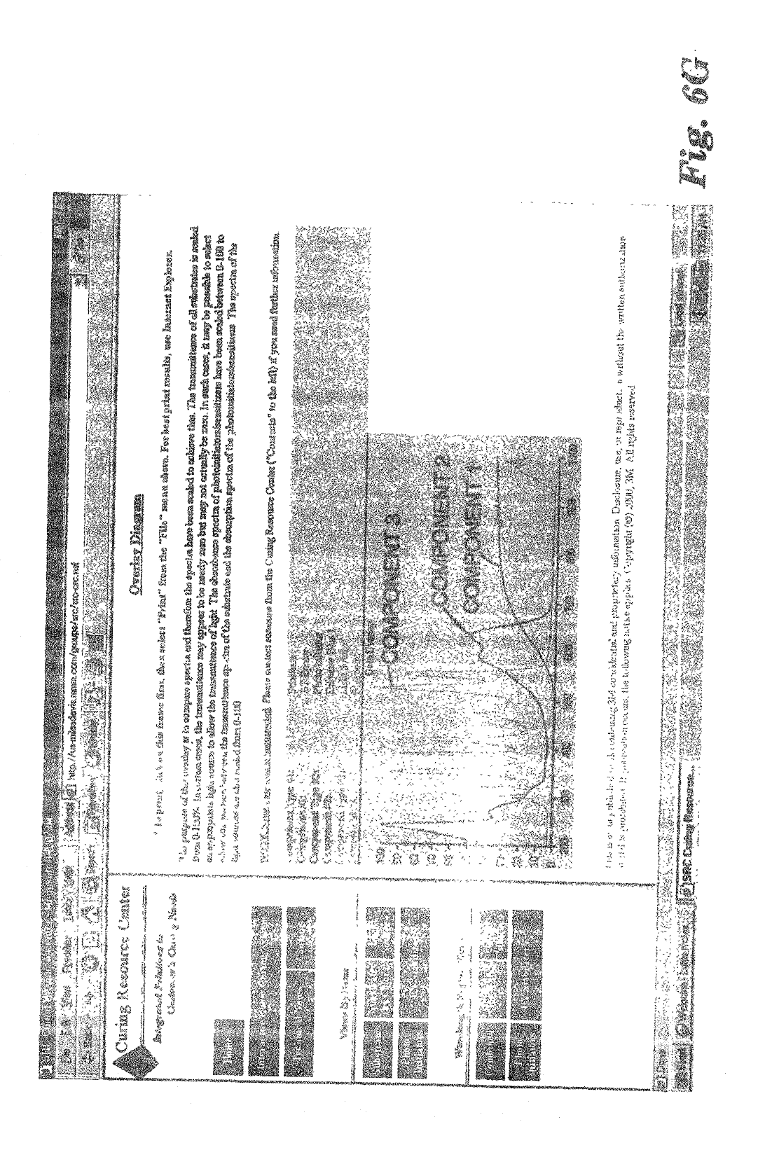

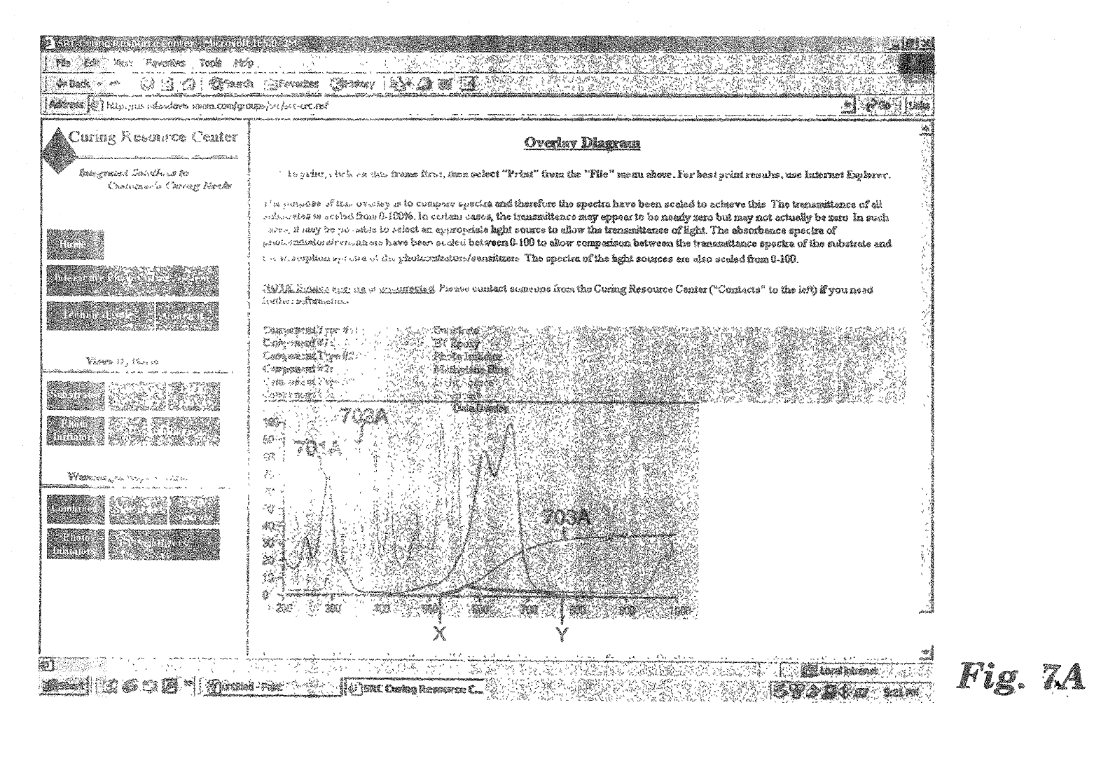

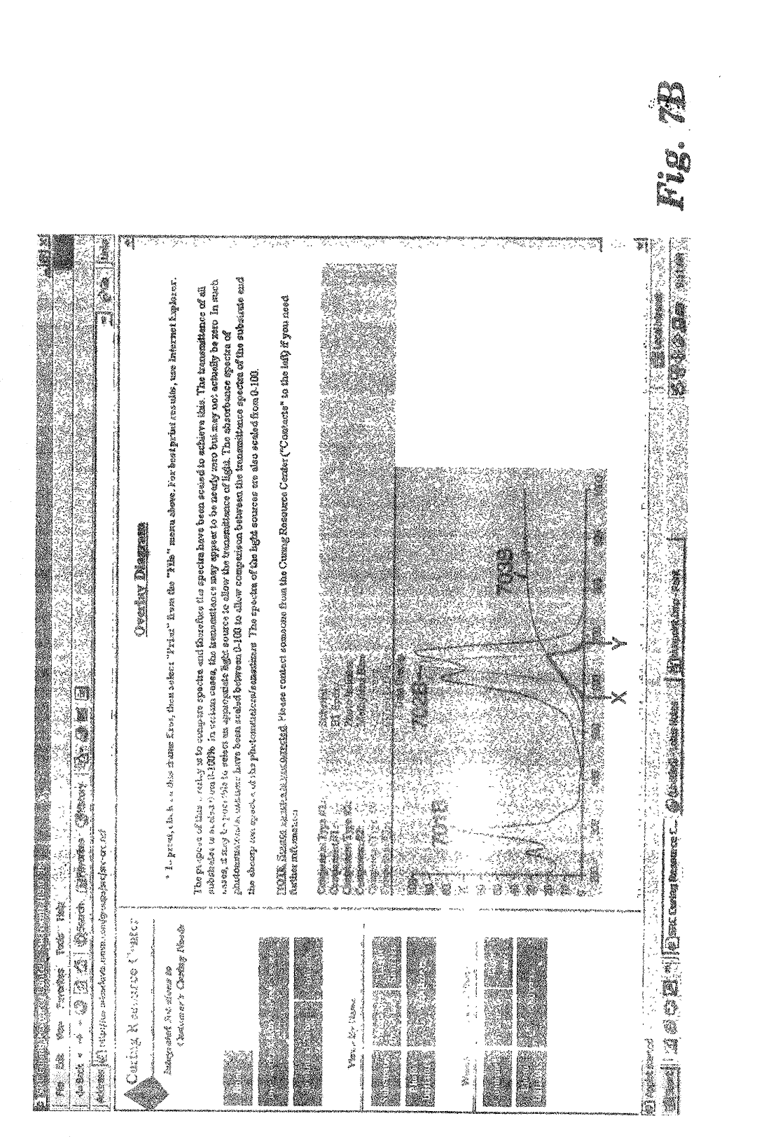

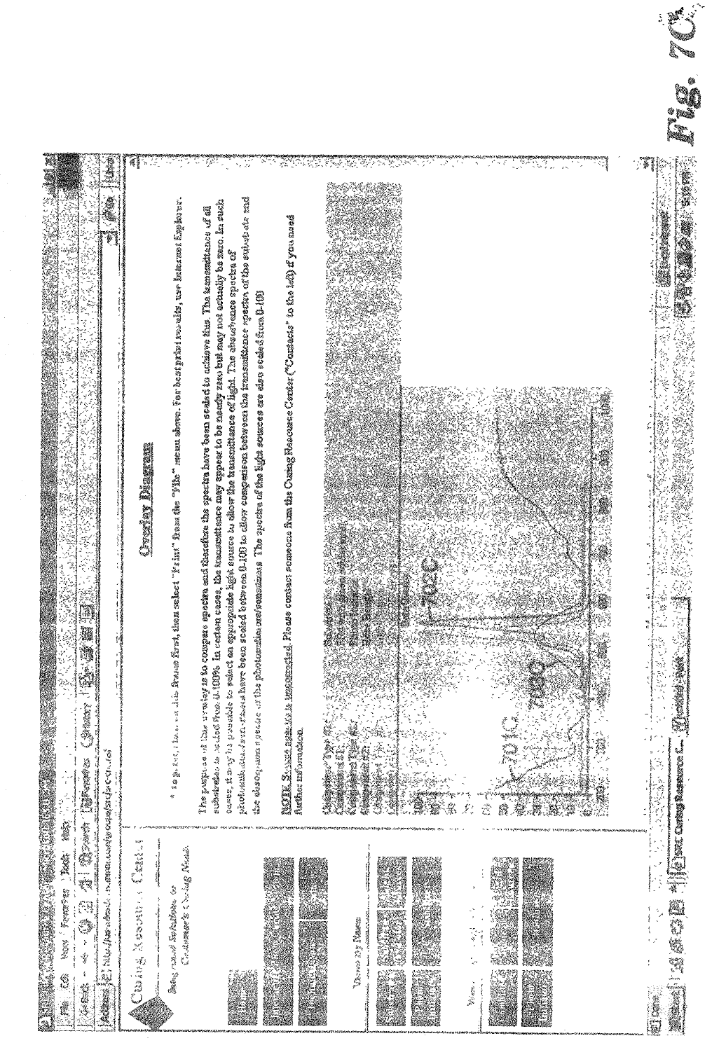

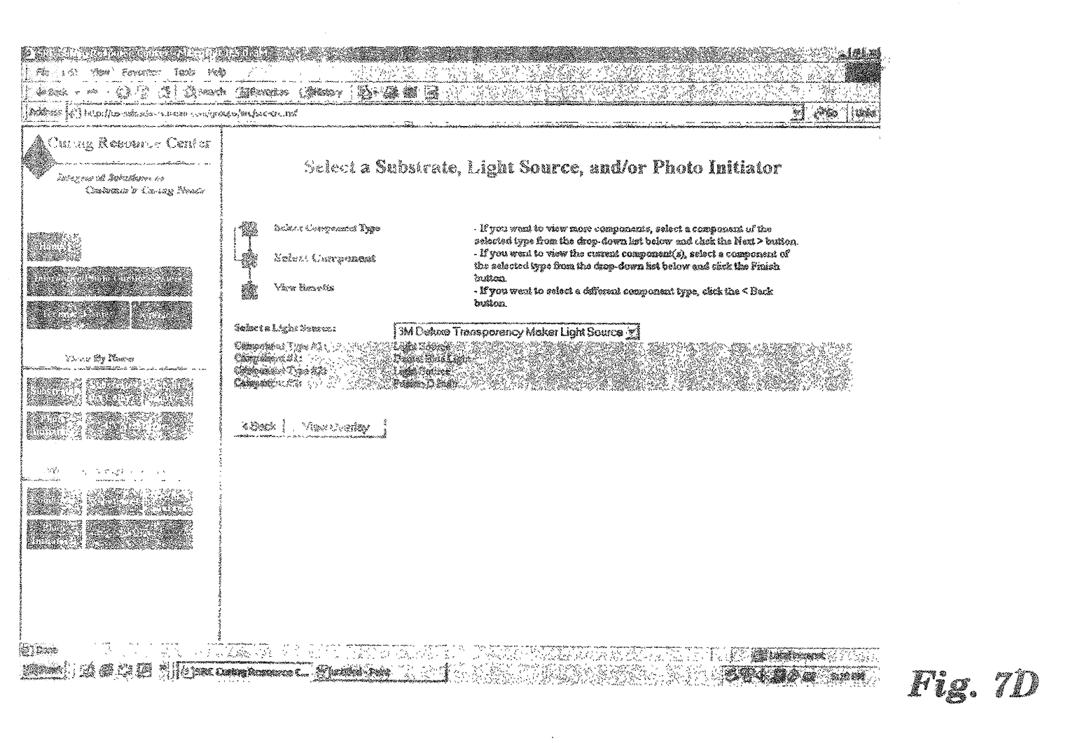

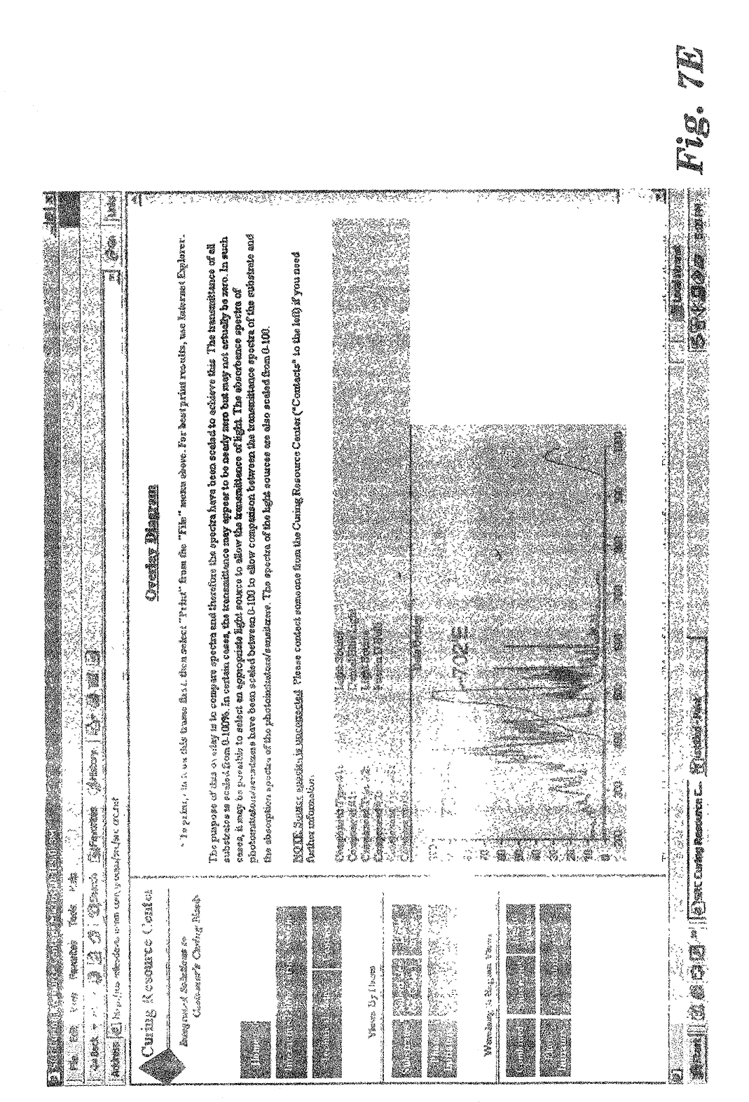

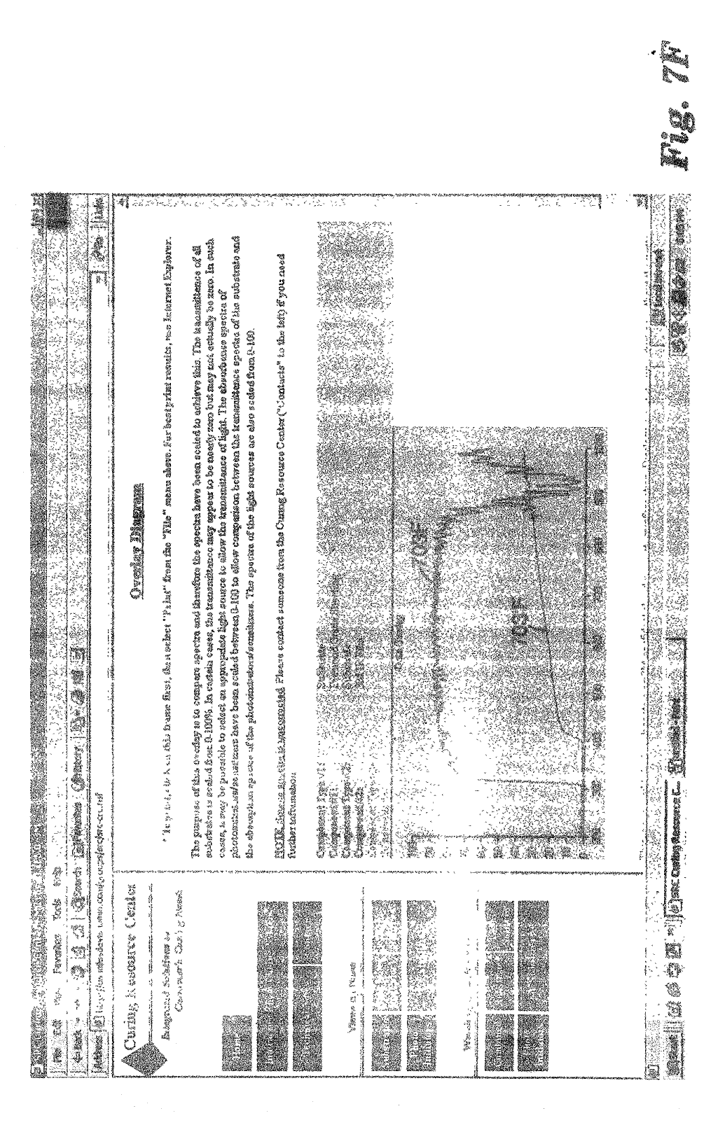

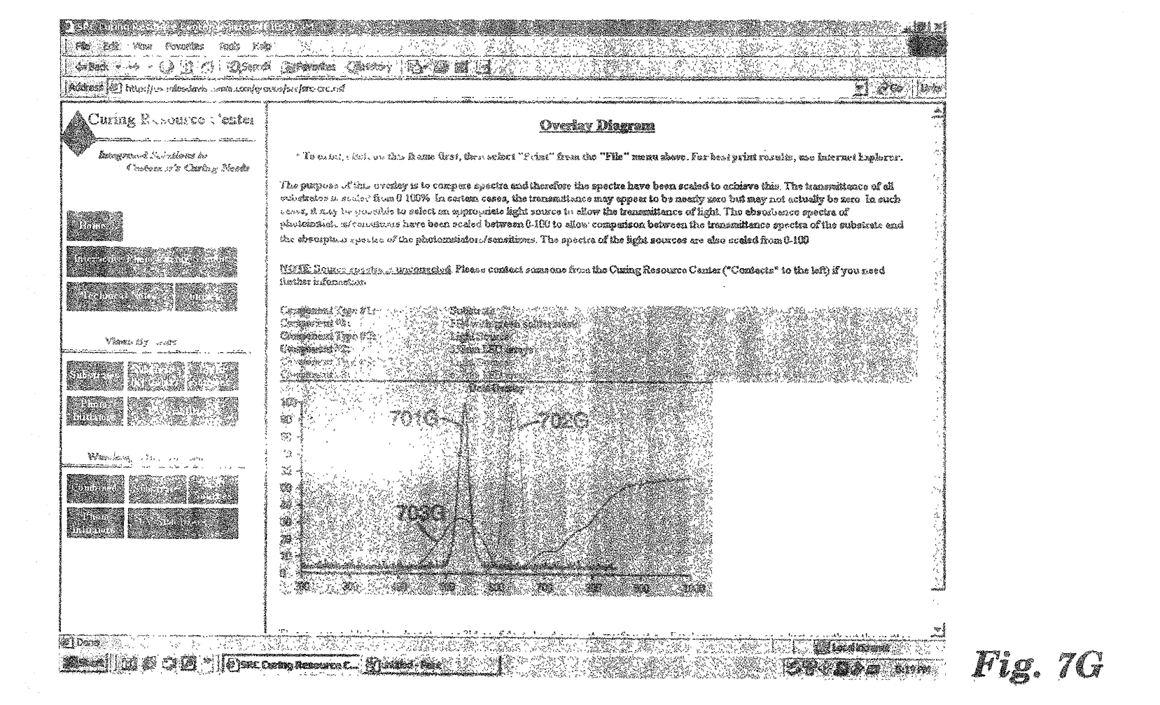

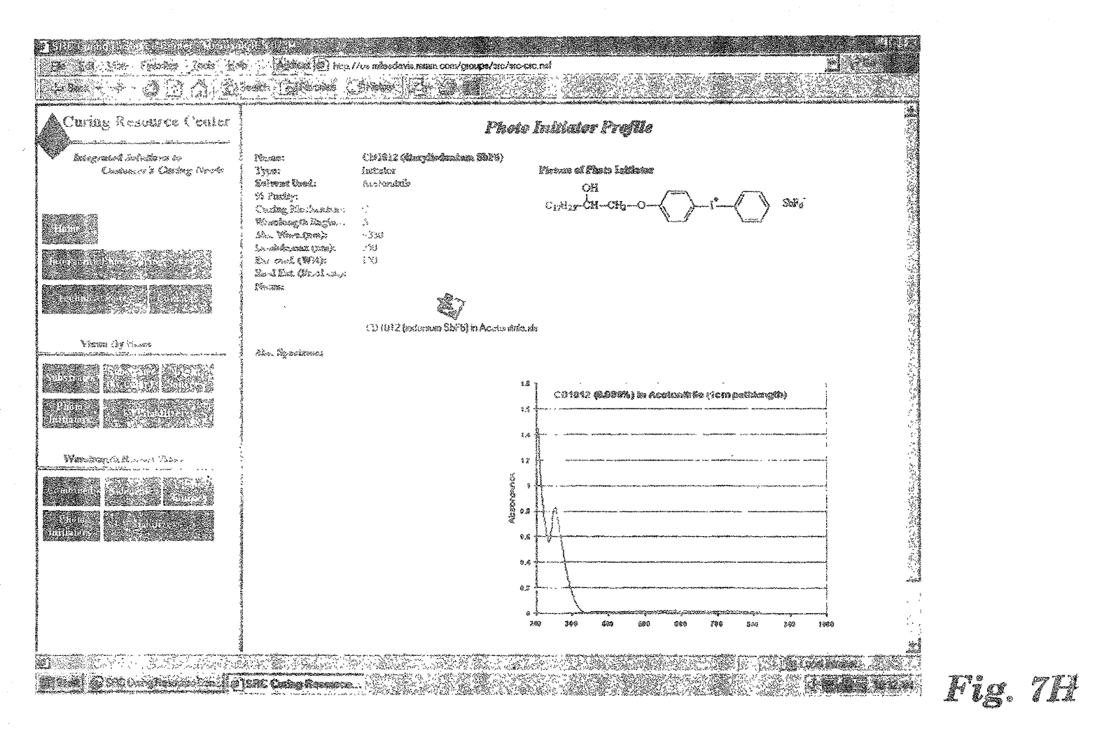

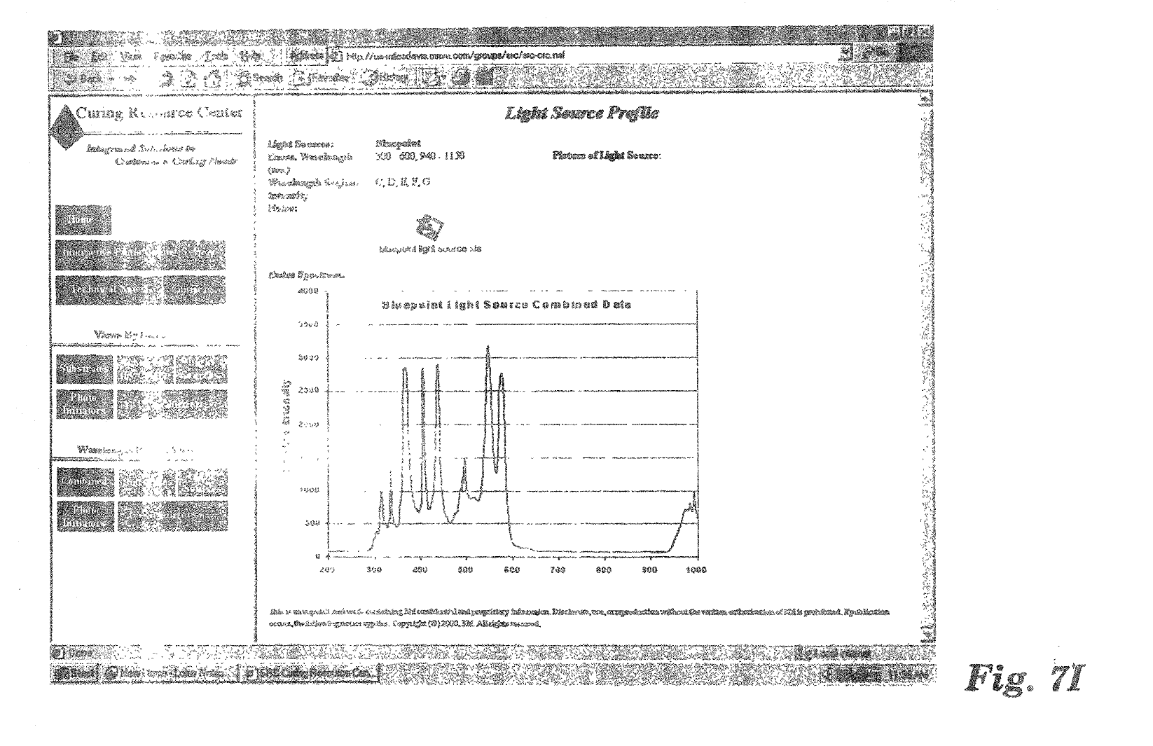

In FIG. 7A, a second overlay diagram is shown. Here the substrate, represented by curve 703A, and the light source, represented by curve 702A are the same as in FIG. 6H. However, the photoinitiator here is Methylene Blue, represented by curve 701A. The area of overlap among the three curves begins at X at approximately 520 nm and continues to Y at approximately 760 nm. At no point does the common area under the curves exceed 10 on the vertical scale.

In FIG. 7B, a third overlay diagram is shown. Here the substrate is again BT Epoxy represented by curve 703B. The photoinitiator is again Methylene blue, represented by curve 701B. This time, the light is a 637 nm LED array represented by curve 702B. In this case the area of overlap among the three curves begins at X at approximately 580 nm and ends at Y at approximately 690 nm. The common area under the curves reaches a high of almost 20 and appears to average almost 10.

In FIG. 7C, a fourth overlay diagram is shown. Here, the substrate is FR4 with green solder mask represented by curve 703C. The photoinitiator is rose bengal and is represented by curve 701C. The light is a 538 nm LED Array. Here you can see a significant area of overlap under the three curves starting at approximately 360 nm and running to approximately 600 nm. From 500-575 nm, the overlap is in the region of peaks for all three elements.

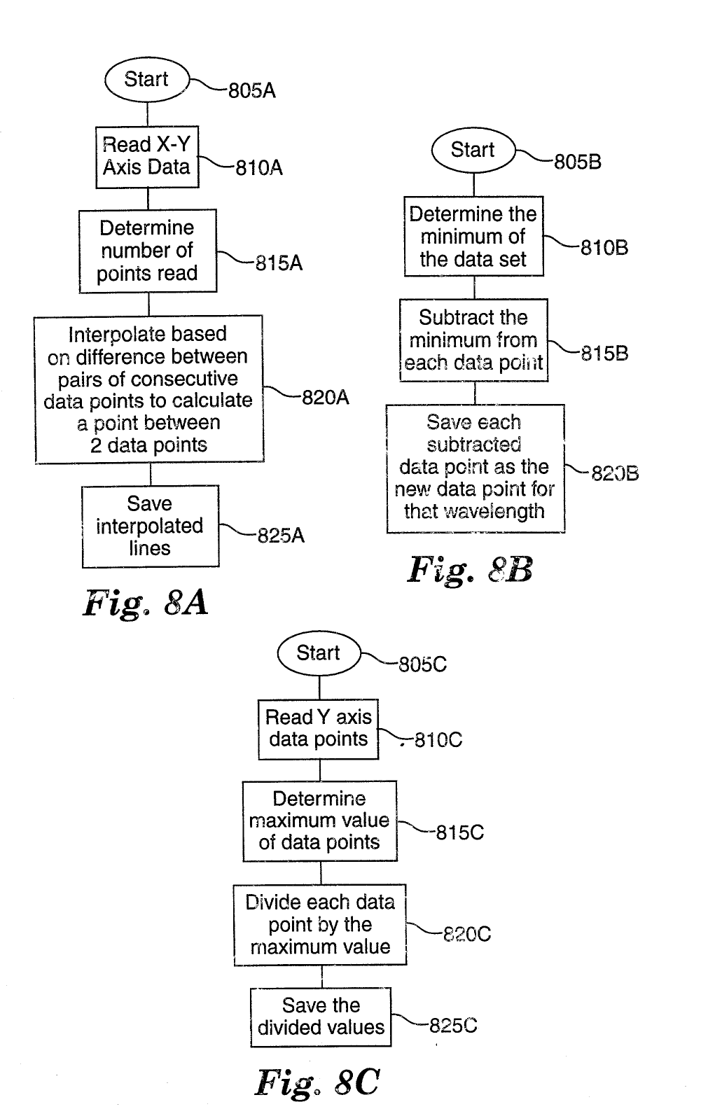

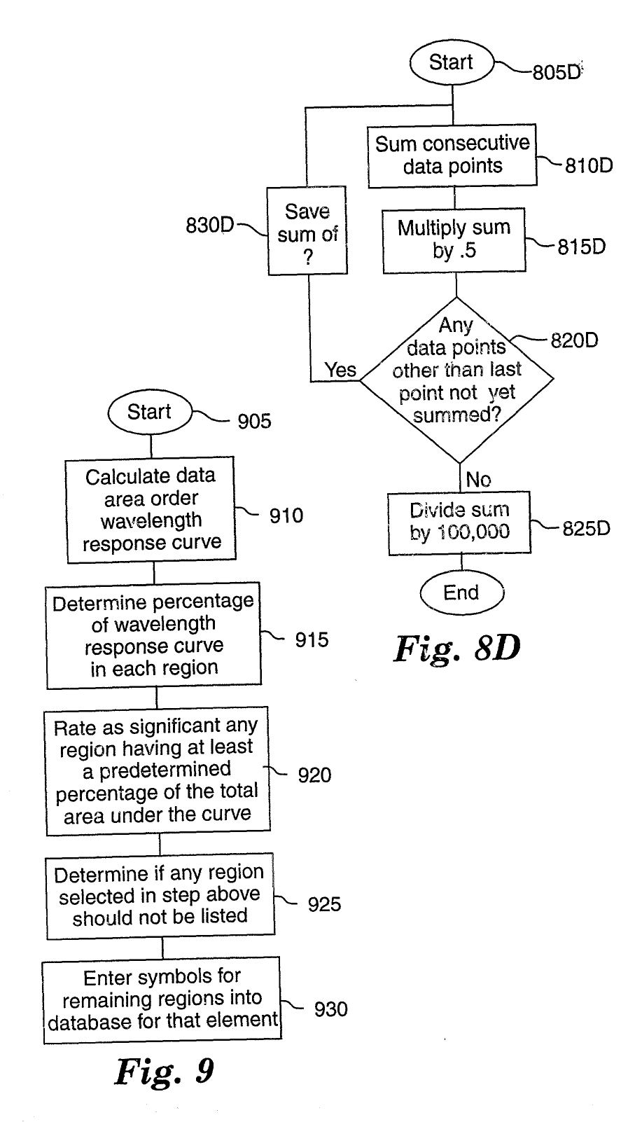

One goal of photocuring system design may be to use the least amount of light energy in order to have the curing take place. This is accomplished by ensuring that light energy is efficiently transferred to the photoinitiator in a region where the photoinitiator can be activated. Graphically, this would be in the area where the curves representing the light source, the photoinitiator and the substrate substantially overlap. In order to determine which of the combinations is the most efficient from a use of light perspective, the common area under the curves for each three component system must be calculated, and the system with the greatest common area is viewed as the most efficient. One way to do this is a well known process of summing trapezoids under the common curve. A flow chart describing the process is shown in FIG. 8D. After starting at block 805D, the process sums consecutive data points at block 810D. The sum of the consecutive data points is then halved (here by multiplication by 0.5) in block 815D. At block 820D, a decision is required. If there are any data points that are not yet summed (other than the last data point in this method because there are no further points with which to form a trapezoid with), the current sum is saved at block 830D and the process moves to the next set of data points back at block 810D. If all of the data points have been summed at block 820D, the process moves to block 825D where in a preferred embodiment the sum is scaled to by a predetermined number to provide a more useful output number. Note however that the scaling is not required, just useful in some cases. A Fortran program for calculating the area is attached by way of example as Appendix 1.

In the four overlays represented in FIGS. 6H and 7A-C, the most efficient system would be the one represented in FIG. 7C since it has the greatest area under the overlapping curves. The least efficient system is represented in FIG. 7A. This system could take a long time (relative to the system of FIG. 7C) to produce curing. It is important to note that the thickness of the substrate, the intensity of the light, the distance of the light from the photoinitiator and any materials intervening between the initiator and the light source, will impact the speed and efficiency of the photocuring system.

On occasion, it is desirable to compare the spectral characteristics of two or more of the same component. Referring now to FIG. 7D, thereshown is the selection page of the present invention whereby two light sources have been chosen for comparison. Here, the Dental Blue light and the Fusion D Bulb have been selected. From FIG. 7E, the spectral characteristics of the two lights are mapped, the Dental Blue Light being represented by curve 702E and the Fusion D Bulb being represented by curve 702E. Here, it can be seen that if a light with a shorter wavelength region is desired, the Fusion D Bulb is a better choice, while the Dental Blue Light would be a better choice for a longer wavelength applications.

In FIG. 7F two substrates, Diamond Grade Sheeting, shown by curve 703F, and 3M IR film, shown by curve 703′F, are compared. Here, the 3M IR film appears to provide good light transmission across a wide range of wavelengths. The Diamond grade sheeting could be used where a light source above 400 nm is selected.

In FIG. 7G, one substrate is compared to two light sources in an attempt to visually determine which light source would more efficiently provide light through the substrate to the photoinitiator. Here, the substrate is FR4 with green solder mask and is represented by curve 703G. A 558 nm LED array light source is represented by curve 702G while a 637 nm LED array is represented by 702′G. From looking at the area of overlap between curves, it can be seen that the 558 nm LED array has significant area of overlap with this substrate while the 637 nm LED array does not. Use of the 637 nm LED array with this substrate would produce a system that would cure very slowly due to the small amount of overlap under the curves.

Referring now to FIG. 7H, there shown is a profile of an element that is stored in the database. In this case, the profile is of an individual photoinitiator. As can be seen from the figure, a number of different pieces of information are stored in the profile. For a photoinitiator, the photoinitiator name, a preferred solvent, a curing mechanism (the mode of propagation of the growing polymer chain such as free radical or cationic), a wavelength region symbol, an absorbance wavelength profile, a chemical structure picture of the photoinitiator, and a link to a data file containing specific values for absorbance at different wavelengths are included in the profile. In this case, the data file is a list of values stored in a Microsoft Excel spreadsheet. However any spreadsheet program with data graphing capability may be used. FIG. 7I likewise shows a profile of a second element, here a light source. In addition to the light source name, a brief description of the emission wavelengths, the wavelength region symbols, a relative intensity wavelength profile and a data file storing relative intensity values are included. A picture of the light source (not shown) could also be included if desired. Although not shown, a substrate profile would include a name, a brief description of the transmission wavelengths, the wavelength region symbols, a relative transmissivity wavelength profile and a data file storing relative transmissivity values and, possible a picture of the substrate.

In order to present information such that meaningful comparisons can be made, data manipulation must occur. In the presently preferred embodiment, different element profiles may have a different number of data points representing the wavelength response of the element. In order to calculate the area under the curves for two or more elements, multiplication of the curves at predetermined points are required. In order to ensure that the predetermined point has a related wavelength response value, interpolation of the response values between existing datapoints may be required. To accomplish this, a process to interpolate between points in a set of discrete data is implemented. Referring now to FIG. 8A, thereshown is an interpolation process that can be used in the present invention. After starting at 805A, the process reads the x and y-axis data points at block 810A. Then, at block 815A, the process determines the number of data points it has read. Then, at block 820A, the process determines the difference between pairs of consecutive datapoints and uses the number of datapoints information to calculate a function for any point between the consecutive datapoints. The process then saves this information at block 825A. A program that implements this process is included as part of Appendix 1. In another preferred embodiment, the data base profiles for each element have the same number of data points for the wavelength response of the element and the data points are all taken at the same set of wavelengths.

Once the continuity of the data between the data points is calculated, the substrate and photoinitiator data is adjusted to a common baseline through use of a process such as the one shown in FIG. 8B. After starting at block 805B, the process determines the minimum value in the set of data points at block 810B. Then, at block 815B, the minimum is subtracted from each data point value. The new subtracted values are then saved. A program that implements this process is included as part of Appendix 1.

Once the baselining process is complete, the data for light sources is then normalized so that relative values can fairly be compared. The normalization process can be implemented according to the process shown in FIG. 8C. After starting at block 805C, the process moves to block 810C where the y-axis data points are read. The process then determines the maximum value out of the set of data points at block 815C. Finally, the process divides each data point by the maximum value at block 820C and saves the divided values at block 825C. A program that implements this process is included as part of Appendix 1.

FIG. 9 is a flow chart of the process through which the presence of a significant wavelength response in a particular region of the wavelength spectrum is determined. After starting at block 905, the process calculates the total area under the wavelength response curve for a selected element at block 910. At block 915, once the wavelength spectrum has been divided into regions, the process determines the percentage of the wavelength response curve area that is in each region. Then at block 920, the process determines, based upon a preselected criteria such as a preselected percentage of the total area that is present in a region, whether the wavelength response level is significant and therefore assigned a symbol. In a preferred embodiment, the symbol is representative of the wavelength region. At block 925, a set of criteria may be identified to determine whether any region selected for a particular element should not be given a symbol. For example, a certain class of initiators may have a significant response in the 200-350 nm region, but they may have further desirable characteristics in a different wavelength region in which they are normally used. In this case, the shorter wavelength region might be discarded. However, this step is an enhancement to the basic inventive process and is not necessary for the inventive process to operate. Lastly, the remaining symbols for the element are entered into the database for that element.

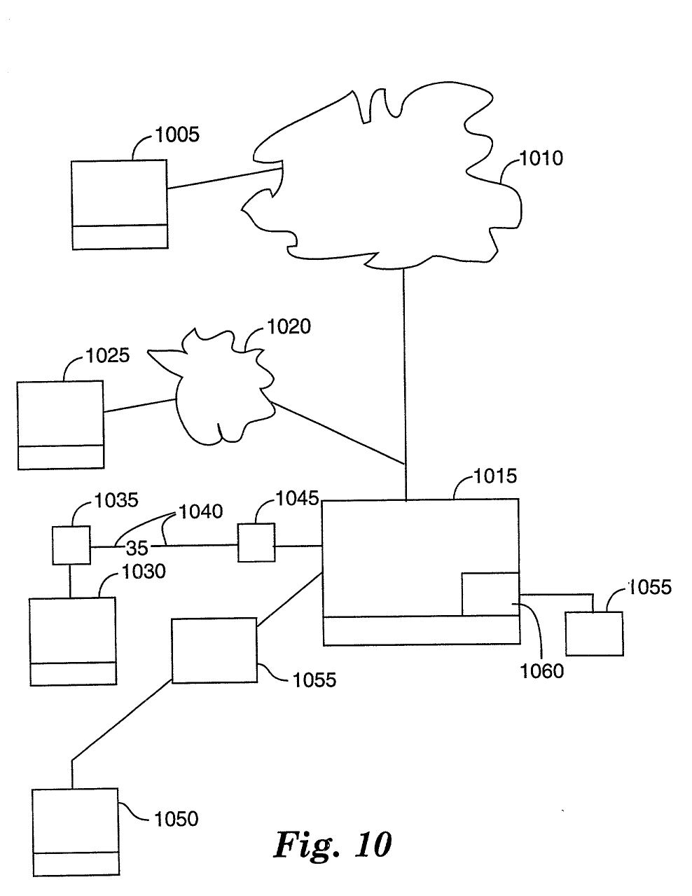

FIG. 10 is a block diagram of a computer and computer network on which the invention may be implemented. Database computer 1015 may be a personal computer on which the database may be stored. A remote terminal, such as a personal computer, may connect to the database computer 1015 via the internet 1010. Alternatively, a remote terminal, such as a personal computer may be connected to the database computer 1015 via a private network 1020 such as an intranet or an extranet. In yet another scheme, remote terminal 1030, which may be a personal computer, may be connected to the database computer via a modem 1035 through phone lines 1040 and through modem 1045. Lastly, remote terminal 1050, which may be a personal computer, may connect to the database computer through an internal network 1055. The database may be stored in memory 1060 on the computer o r may be stored on a CD, floppy disk, zip disk or other storage media and accessed through a media reader 1055 such as a CD drive, floppy disk drive, zip drive or other media reader.

FIG. 11 is a flowchart showing a process for taking data from the database and displaying the information concerning one or more system elements that have been selected by the user. After starting at block 1100, the process reads the X coordinates from a passed parameter for each element chosen at block 1105. Then at block 1110, the process reads a Max Y coordinate from a passed parameter for each system element. The process then determines the largest X coordinate at block 1115. Then, at block 1120, the process determines the Y coordinate spacing form the Max Y coordinate. Lastly, the process draws the wavelength response curve of the selected elements, proportionally to the largest X coordinate by connecting X coordinates in equal Y coordinates at block 1125. A sample program in HTML for this process is listed in Appendix

The foregoing has been a description of a novel and non-obvious tool for creating photocuring systems. The description is meant as an explanation of how to make and use the invention. The inventors define the scope of their invention through the claims attached below. We claim:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1) A database for storing information, comprising:
a first element type field for storing information on a plurality of first elements;
a second element type field, different than the first element type field, for storing information on a plurality of second elements;
the first and second element types being selected from the list of photocuring system elements including substrates, photoinitiators, light sources, sensitizers, UV stabilizers, pigments and dyes; and
the first element type field and second element type field each including a name for each element and a representation of a wavelength response for each element.

2) The database of claim 1, wherein:
the wavelength response for each element is broken into wavelength regions, each wavelength region be represented by a symbol.

3) The database of claim 2, wherein:
the wavelength response is for wavelengths between 200 nm and 1000 nm and each wavelength region is 50 nm wide.

4) The database of claim 1, further comprising:
a third element type, different than the first and second element types, selected from the list of photocuring system elements, the third element type field including a name for each element and a representation of a wavelength response for each element.

5) A method of optimizing the performance of a light curing polymer system including multiple component types, the component types including a light source, a photoinitiator and a substrate, where the light source is arranged to radiate its light through the substrate to the photoinitiator, the light source operating at a set of wavelengths, the substrate allowing only a set of wavelengths of light to pass there through and the photoinitiators only activated when it is hit with a set of wavelengths, the method of optimizing including the steps of:
selecting a first component, said first component operating at first set of wavelengths defining a first wavelength spectrum;
selecting a second component from of a type different than the type of the first component, the second component operating at a second set of wavelengths and having a second wavelength spectrum, at least one of said second set of wavelengths being present in said first set of wavelengths.

6) The method of claim 5, wherein wavelength regions are established and a representative name is assigned to each wavelength region.

7) The method of claim 6, wherein the set of wavelengths for each component are identified using the representative names for the wavelength regions into which the component wavelength set fall.

8) The method of claim 7, wherein said representative names of the selected first component are compared to the representative names of the plurality of second components so that only a second component having at least one representative name in common with the selected first component can be chosen.

9) The method of claim 8, comprising the further step of:
selecting a third component different than the first or second component from a plurality of possible third components, the third component operating at a third set of wavelengths and having a third wavelength spectrum, at least one of said third set of wavelengths being present in said first set of wavelengths.

10) A method of comparing characteristics of components of a light curing polymer system where a light source is directed through the substrate to the photoinitiator, the light source operating at a first range of wavelengths, the substrate allowing only a second range of wavelengths of light to pass there through and the photoinitiator only being activated when it is irradiated with a third range of wavelengths, the method of comparing including the steps of:
storing the characteristics of the constituents in memory, the characteristics including name and wavelength response;
selecting a first component;
selecting a second component;
graphically displaying on the same display, the name and wavelength response of the first component and the second component.

11) The method of claim 10, further comprising the step of:
determining an area of an overlapping region of the wavelength responses of the first and second components.

12) The method of claim 11, wherein the area determination is performed using a sum of the rectangles under the overlapping curves method.

13) A method for designing photocuring systems, comprising the steps of:
connecting a user terminal with a remote computer storing a photocuring database containing a first element type field for storing information on a plurality of first elements, a second element type field, different than the first element type field, for storing information on a plurality of second elements, the first and second element types being selected from the list of photocuring system elements including substrates, photoinitiators, light sources, sensitizers, UV stabilizers, pigments and dyes and the first element type field and second element type field each including a name for each element and a representation of a wavelength response for each element;
transmitting a first signal representative of a selection of a first element to the remote computer;
transmitting a second signal representative of a selection of a second element to the remote computer;
receiving from the remote computer a signal containing information on the wavelength response of the first and second elements.
